(19) United States
(12) Patent Application Publication
(10) Pub. No.: US 2020/0148907 A1
(43) Pub. Date: May 14, 2020

(54) NEAR INFRARED (NIR) LASER MARKABLE COMPOSITIONS

(71) Applicants: AGFA NV, Mortsel (BE); AGFA-GEVAERT NV, Mortsel (BE)

(72) Inventors: Faima LAZREG, Mortsel (BE); Johan LOCCUFIER, Mortsel (BE)

(21) Appl. No.: 16/627,428

(22) PCT Filed: Jun. 29, 2018
(86) PCT No.: PCT/EP2018/067562

§ 371 Date: Dec. 30, 2019

(30) Foreign Application Priority Data
Jul. 3, 2017 (EP) 17179295.5

(51) Int. Cl. C09D 11/50; B41M 5/46; B41M 5/50; C09D 11/328; C09D 11/037

(52) U.S. Cl. CPC C09D 11/50; B41M 5/465; C09D 11/037; C09D 11/328; B41M 5/502

(57) ABSTRACT

A laser markable composition has an improved stability towards the environment by using specific Near Infrared absorbing compounds.

### CROSS REFERENCE TO RELATED APPLICATIONS

This application is a 371 National Stage Application of PCT/EP2018/067562, filed Jun. 29, 2018. This application claims the benefit of European Application No. 17179295.5, filed Jul. 3, 2017, which is incorporated by reference herein in its entirety.

### BACKGROUND OF THE INVENTION

### 1. Field of the Invention

The present invention relates to Near Infrared (NIR) laser markable compositions having an improved stability towards the environment and to laser markable articles comprising such compositions.

### 2. Description of the Related Art

Laser marking, i.e. providing information on for example packaging or a security document by means of a laser, is gaining interest as an answer to an increasing demand for personalization, mass customization, security, traceability and anti-counterfeiting.

Several laser marking technologies co-exist in the field.

Laser induced carbonization is one of the main technologies. However, laser marking based on carbonization is limited to black and white images.

The use of metal oxides, for example ammonium octamolybdate or molybdenum trioxide, has been developed as an alternative approach for laser marking, as disclosed in for example WO2002/074548 (Datalase) or WO2008/075101 (Siltech). However, also this laser marking technology is limited to black and white images.

WO2013/014436 (Datalase) discloses a diacetylene-based technology enabling multicolour laser marking.

Another multicolour laser marking technology makes use of leuco dyes, as disclosed in for example EP-A 2648920 (Agfa Gevaert).

Laser marking is typically carry out by exposing a laser markable composition to infrared (IR) radiation. The absorbed infrared. radiation is converted to heat, which then triggers a colour change.

To increase the laser marking sensitivity, IR radiation absorbing compounds are often added to the laser markable compositions. The presence of such compounds may result in higher laser marked densities upon IR exposure.

As there is an increasing interest in using Near Infrared (NIR) lasers for laser marking, there is also an increasing demand for NIR, absorbing compounds that increase the laser marking sensitivity.

Useful NIR absorbing compounds have enough absorption in the NIR region, i.e. between 750 and 2500 nm, to increase the laser marking sensitivity. However, their absorption in the visible region, i.e. between 400 and 700, must be as low as possible, to avoid background colouration.

WO2007/141522 (Datalase) disclose laser markable compositions wherein reduced Indium Tin Oxide (r-ITO) is used as NIR absorbing compound.

In WO2015/015200 (Datalase) tungsten oxide compounds are disclosed as NIR absorbing compounds.

NIR absorbing cyanine dyes have also been proposed for use in laser markable compositions. An advantage of such NIR absorbing cyanine dyes is their narrow absorption peak in the NIR region, resulting in a low absorption in the visible region, i.e. a low background colour, and making multicolour laser marking possible, as disclosed in WO2014/057018 (Agfa Gevaert).

A disadvantage of the disclosed NIR absorbing cyanine dyes is often their limited stability towards for example heat, moisture, UV radiation, or oxygen. This may result in lower laser marking densities and/or an increased background colour upon storage of the laser markable articles.

There is thus a need for laser markable compositions containing NIR absorbing compounds having a low absorption in the visible region and a narrow absorption peak in the IR region and having an improved stability towards the environment.

### SUMMARY OF THE INVENTION

It is an object of the present invention to provide laser markable compositions having an improved stability towards heat, radiation, moisture or oxygen.

This object is realised with laser markable compositions as defined below.

It was found that by using specific cyanine compounds as NIR absorber, more stable laser markable composition could be obtained.

Further objects of the invention will become apparent from the description hereinafter.

### DETAILED DESCRIPTION OF THE PREFERRED EMBODIMENTS

### Definitions

Unless otherwise specified the term “alkyl” means all variants possible for each number of carbon atoms in the alkyl group i.e. methyl, ethyl, for three carbon atoms: n-propyl and isopropyl; for four carbon atoms: n-butyl, isobutyl and tertiary-butyl; for five carbon atoms: n-pentyl, 1,1-dimethyl-propyl, 2,2Dimethylpropyl and 2-methyl-butyl, etc.

Unless otherwise specified a substituted or unsubstituted alkyl group is preferably a C₁ to C₆-alkyl group.

Unless otherwise specified a substituted or unsubstituted alkenyl group is preferably a C₂ to C₆-alkenyl group.

Unless otherwise specified a substituted or unsubstituted alkynyl group is preferably a C₂ to C₆-alkynyl group.

Unless otherwise specified a substituted or unsubstituted aralkyl group is preferably a phenyl or naphthyl group including one, two, three or more C₁ to C₆-alkyl groups.

Unless otherwise specified a substituted or unsubstituted alkaryl group is preferably a C₇ to C₂₀-alkyl group including a phenyl group or naphthyl group.

Unless otherwise specified a substituted or unsubstituted aryl group is preferably a phenyl group or naphthyl group.

Unless otherwise specified a substituted or unsubstituted heteroaryl group is preferably a five- or six-membered ring substituted by one, two or three oxygen atoms, nitrogen atoms, sulphur atoms, selenium atoms or combinations thereof.

The term “substituted”, in e.g. substituted alkyl group means that the alkyl group may be substituted by other atoms than the atoms normally present in such a group, i.e. carbon and hydrogen. For example, a substituted alkyl group may include a halogen atom or a thiol group. An unsubstituted alkyl group contains only carbon and hydrogen atoms.

Unless otherwise specified a substituted alkyl group, a substituted alkenyl group, a substituted alkynyl group, a substituted aralkyl group, a substituted alkaryl group, a substituted aryl and a substituted heteroaryl group are preferably substituted by one or more constituents selected from the group consisting of methyl, ethyl, n-propyl, isopropyl, n-butyl, isobutyl and tertiary-butyl, ester, amide, ether, thioether, ketone, aldehyde, sulfoxide, sulfone, sulfonate ester, sulphonamide, —Cl, —Br, —I, —OH, —SH, —CN and —NO₂.

### Laser Markable Composition

The laser markable composition comprises a Near InfraRed (NIR) absorbing cyanine compound as described below and a colour forming agent.

The SIR region of the spectrum is considered to be between 750 and 2500 nm.

The composition may further comprise other ingredients, such as an acid scavenger and a UV absorber.

The laser markable composition may also comprise a dye or pigment that enhances the contrast between the laser marked image and the background colour.

### NIR Absorbing Compound

The laser markable composition according to the present invention comprises a NIR absorbing compound having a chemical structure according to Formula I,

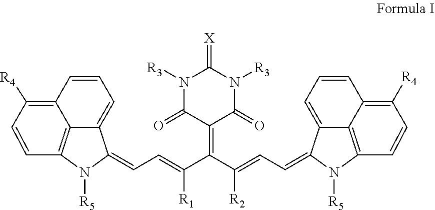

wherein

X is O or S,

R₁ and R₂ represent the necessary atoms to form a substituted or unsubstituted 5 or 6 membered ring,

R₃ and R₅ are independently selected from the group consisting of an unsubstituted alkyl group, an unsubstituted alkenyl group, an unsubstituted alkynyl group, an unsubstituted aralkyl group, an unsubstituted alkaryl group and a substituted or unsubstituted (hetero) aryl group,

R₄ is selected from the group consisting of a hydrogen, an unsubstituted alkyl group, an unsubstituted alkenyl group, an unsubstituted alkynyl group, an unsubstituted aralkyl group, an unsubstituted alkaryl group, a substituted or an unsubstituted (hetero) aryl group, a halogen, an unsubstituted alkoxy group, a substituted or an unsubstituted aryloxy group, a substituted or an unsubstituted heteroaryloxy group, an ester, an amine, an amide, a nitro, a thioalkyl group, a substituted or an unsubstituted thioaryl group, a substituted or an unsubstituted thioheteroaryl group, a carbamate, a carbamide, a sulfonamde, a sulfoxide and a sulfone, with the proviso that all hydrocarbon groups in Formula I are straight chain hydrocarbon groups.

A straight chain hydrocarbon group as used herein means a linear hydrocarbon group, which is not further functionalized with hydrocarbon substituents.

A hydrocarbon group as used herein means a functional group only consisting of carbon atoms in the main chain or ring.

The hydrocarbon group is preferably selected from the group consisting of an alkyl group, an alkenyl group, an alkynyl group and an aralkyl group.

In a preferred embodiment, R₃ and R₅ are independently selected from the group consisting of an unsubstituted alkyl group, an unsubstituted alkaryl group and an unsubstituted (hetero) aryl group.

In a more preferred embodiment, R₃ and R₅ are independently selected from the group consisting of an unsubstituted lower alkyl group containing no more then six carbon atoms and an unsubstituted alkaryl group.

In a particularly preferred embodiment, R₃ and R₅ are independently selected from the group consisting of a methyl group, an ethyl group, a n-propyl group, a n-butyl group, a benzyl group and an aryl group.

In all embodiments described above, R₄ is preferably selected from the group consisting of a hydrogen, a halogen, a straight chain unsubstituted alkyl group and a straight chain unsubstituted alkoxy group.

In all these embodiments, R₄ is more preferably selected from the group consisting of a hydrogen, a chlorine, a bromine, a methyl group, an ethyl group, a methoxy group, an ethoxy group, a n-propoxy group and a n-butoxy group.

The NIR absorbing compound has preferably a chemical structure according to Formula II,

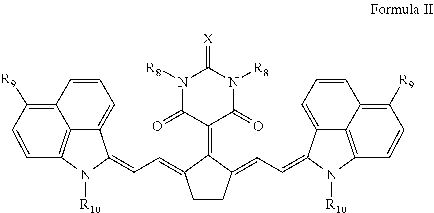

wherein

X is O or S,

R₈ and R₁₀ are independently selected from the group consisting of an unsubstituted alkyl group, an unsubstituted alkenyl group, an unsubstituted alkynyl group, an unsubstituted aralkyl group, an unsubstituted alkaryl group and a substituted or unsubstituted (hetero)aryl group,

R₉ is selected from the group consisting of a hydrogen, an unsubstituted alkyl group, an unsubstituted alkenyl group, an unsubstituted alkynyl group, an unsubstituted aralkyl group, an unsubstituted alkaryl group, a substituted or an unsubstituted (hetero) aryl group, a halogen, an unsubstituted alkoxy group, a substituted or an unsubstituted aryloxy group, a substituted or an unsubstituted heteroaryloxy group, an ester, an amine, an amide, a nitro, a thioalkyl group, a substituted or an unsubstituted thioaryl group, a substituted or an unsubstituted thioheteroaryl group, a carbamate, a carbamide, a sulfonamide, a sulfoxide and a sulfone.

In a particularly preferred embodiment, R₉ is selected from the group consisting of a hydrogen, a chlorine, a bromine, a methyl group, an ethyl group, a methoxy group, an ethoxy group, a n-propoxy group and a n-butoxy group.

Specific examples of NIR absorbing compounds according to the present invention are given in Table 1 without being limited thereto.

TABLE 1

| STRUCTURES | IR Absorbers |
|---|---|
| 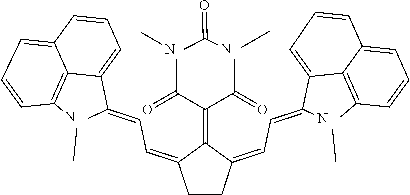 | IR-1 |
| 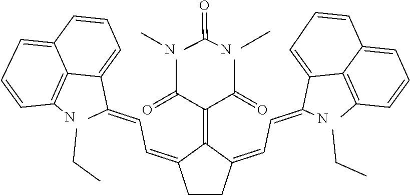 | IR-2 |
| 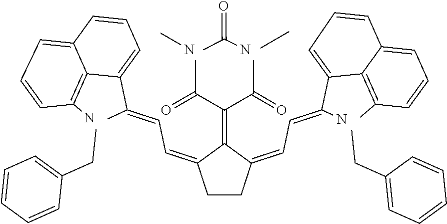 | IR-3 |
| 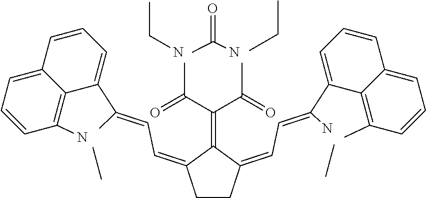 | IR-4 |
| 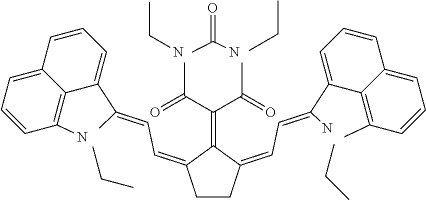 | IR-5 |
| 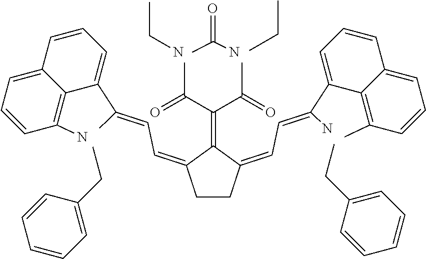 | IR-6 |
| 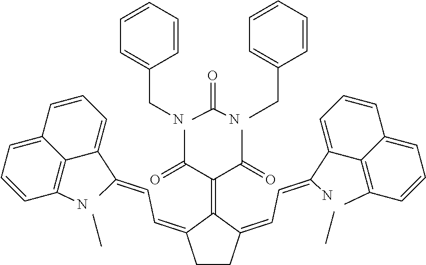 | IR-7 |
| 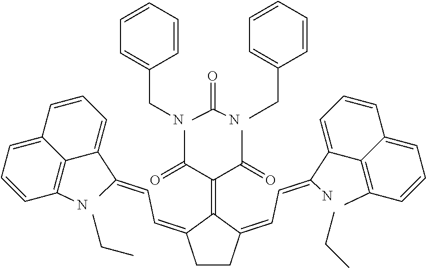 | IR-8 |
| 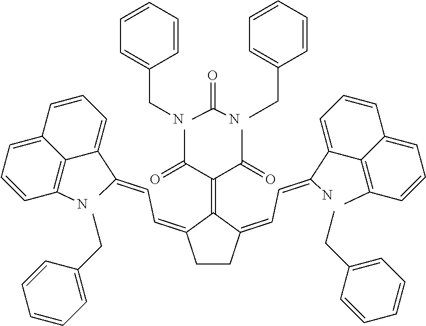 | IR-9 |
| 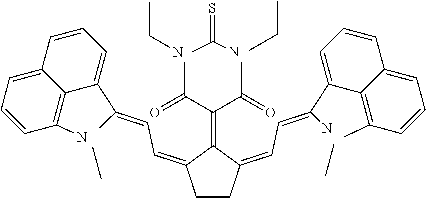 | IR-10 |
| 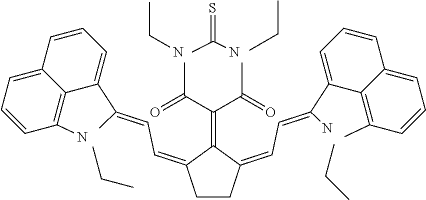 | IR-11 |
| 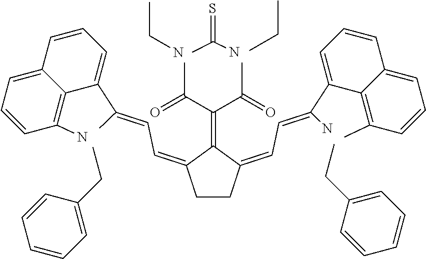 | IR-12 |
| 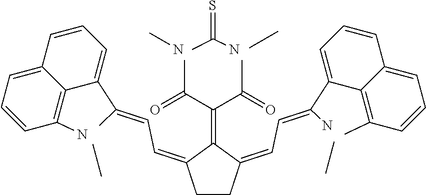 | IR-13 |
| 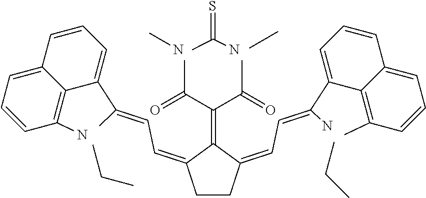 | IR-14 |
| 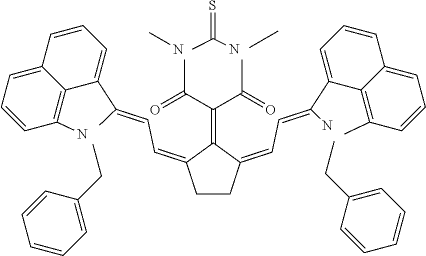 | IR-15 |
| 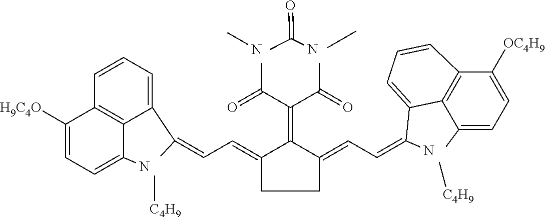 | IR-16 |
| 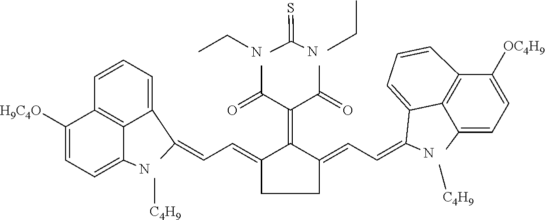 | IR-17 |
| 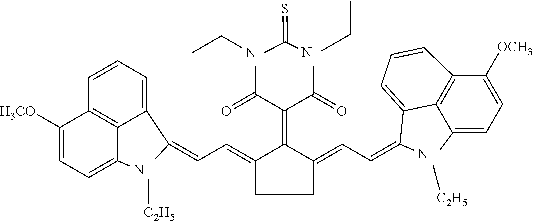 | IR-18 |
| 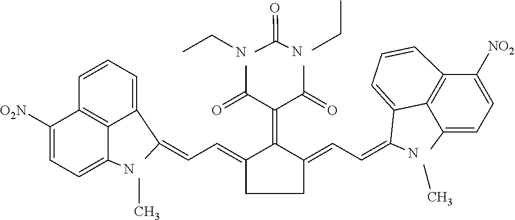 | IR-19 |
| 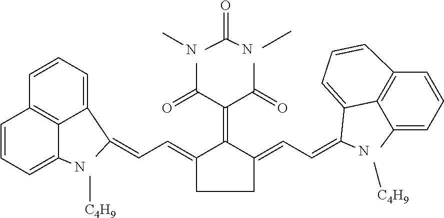 | IR-20 |
| 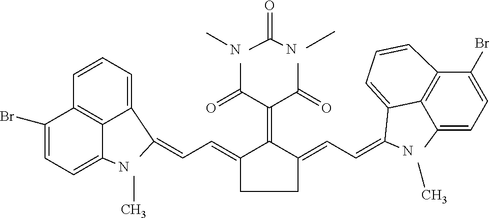 | IR-21 |
| 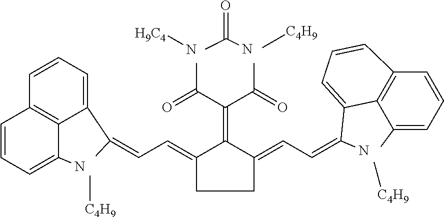 | IR-22 |
| 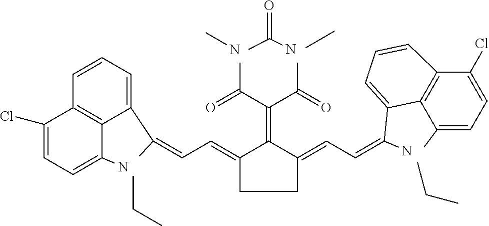 | IR-23 |
| 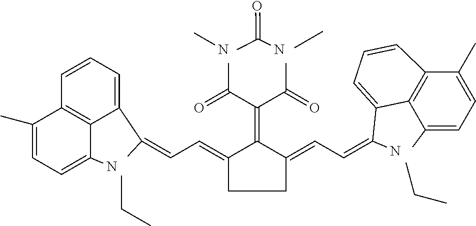 | IR-24 |
| 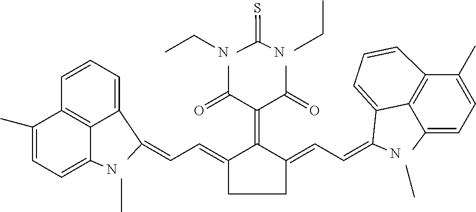 | IR-25 |
| 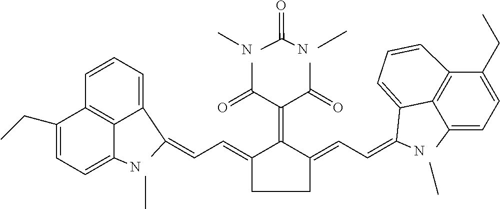 | IR-26 |
| 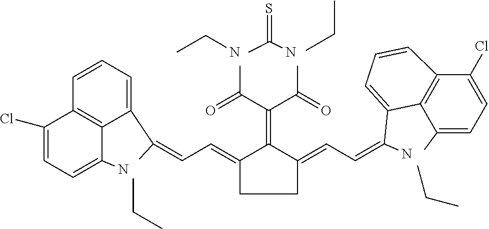 | IR-27 |

The laser markable composition may comprise one or more NIR absorbing compounds as described above.

The total concentration of the NIR absorbing compound. is preferably between 0.001 and 50 wt %, more preferably between 0.005 and 10 wt %, most preferably between 0.01 and 5 wt %, relative to the total weight of the composition.

The laser markable composition may comprise in addition to the NIR absorbing compound as described above other infrared absorbing compounds, i.e. infrared absorbing pigments or dyes as disclosed in for example WO2016/184881 (Agfa Gevaert), paragraph. [042] to [058]).

### Colour Forming Agent

The laser markable composition comprises a colour forming agent, which is capable of forming a colour upon NIR laser exposure.

All known colour forming agents may be used.

A transition metal oxide, such as molybdenum trioxide, has been disclosed in WO2008/075101(Siltech).

An oxyanion of a multivalent metal, such as ammonium octyl molybdate, has been disclosed in WO2002/074548 (Datalase) and WO2007/012578 (Datalase).

These colour forming agents are capable of forming a black colour upon laser marking.

Diacetylene compounds, such as disclosed in WO2013/014436 (Datalase) are capable of forming multiple colours.

Preferred colour formers are leuco dyes, as described below. A leuco dye is preferably used in combination with a developing agent.

Also, a combination of different colour forming agents may be used, for example to produce different colours. In WO2013/068779 (Datalase), a combination of a diacetylene compound and a leuco dye is used to produce a full colour image upon exposure to UV and IR radiation.

### Leuco Dye

A leuco dye is a substantially colourless compound, which may form a coloured dye upon inter- or intramolecular reaction. The inter- or intramolecular reaction may be triggered by heat formed during exposure with an NIR laser.

Examples of leuco dyes that may be used are disclosed in WO2015/165854 (Agfa Gevaert), paragraph [069] to [093].

### Developing Agent

A developing agent is capable of reacting with a colourless leuco dye resulting in the formation of a coloured dye.

The developing agent may not react, or at least not substantially, with the leuco dye before laser marking, i.e. exposure to NIR radiation, to avoid background coloration. The developing agent and the leuco dye thus have to be shielded from each other before laser marking.

One way to achieve such a shielding is by using a so-called developing agent precursor, which does not react with the leuco dye. Upon exposure to NIR radiation, the developing agent precursor releases a developing agent, which may react with the leuco dye thereby forming a colour.

Another way to achieve the shielding is the encapsulation of the leuco dye and/or the developing agent. Upon exposure to NIR radiation, the capsules rupture, whereupon the leuco dye and the developing agent may react with each other thereby forming a colour.

Various electron accepting substances may be used as developing agent in the present invention. Examples thereof include phenolic compounds, organic or inorganic acidic compounds and esters or salts thereof.

Examples of developing agents that may be used are disclosed in WO2014/124052 (FujiFilm Hunt Chemicals), paragraph [0069] to [0073].

Preferred developing agents are metal salts of a carboxylic acid, as disclosed in WO2006/067073 (Datalase), page 3, line 4 to page 5, line 31.

A preferred colour developing agent is a metal salt of salicylic acid, for example zinc salicylate. A particularly preferred colour developing agent is zinc 3,5-bis(α-methylbenzyl) salicylate.

All publicly-known thermal acid generators can be used as developing agent precursors. Thermal acid generators are for example widely used in conventional photoresist material. For more information see for example “Encyclopaedia of polymer science”, 4^{th} edition, Wiley or “Industrial Photoinitiators, A Technical Guide”, CRC Press 2010.

Preferred classes of photo- and thermal acid generators are iodonium salts, sulfonium salts, ferrocenium salts, sulfonyl oximes, halomethyl triazines, halomethylarylsulfone, α-haloacetophenones, sulfonate esters, t-butyl esters, allyl substituted phenols, t-butyl carbonates, sulfate esters, phosphate esters and phosphonate esters.

Particularly preferred developing agent precusors are disclosed in WO2007/088104 (Datalase), page 2, line 18 to page 5, line 16 and WO2015/091688 (Agfa Gevaert), paragraphs [052] to [072].

### UV Absorbers

The laser markable composition may also comprise a UV-absorber. The UV-absorber is however preferably present in a protective layer, provided on top of the printed laser markable image.

Examples of suitable UV-absorbers include 2-hydroxyphenyl-benzophenones (BP) such as Chimassorb™ 81 and Chimassorb™ 90 from BASF; 2-(2-hydroxyphenyl)-benzotriazoles (BTZ) such as Tinuvin™ 109, Tinuvin™ 1130, Tinuvin™ 171, Tinuvin™ 326, Tinuvin™ 328, Tinuvin™ 384-2, Tinuvin™ 99-2, Tinuvin™ 900, Tinuvin™ 928, Tinuvin™ Carboprotect™, Tinuvin™ 360, Tinuvin™ 1130, Tinuvin™ 327, Tinuvin™ 350, Tinuvin™ 234 from BASF, Mixxim™ BB/100 from FAIRMOUNT, Chiguard 5530 from Chitec; 2-hydroxy-phenyl-s-triazmes (HPT) such as Tinuvin™ 460, Tinuvin™ 400, Tinuvin™ 405, Tinuvin™ 477, Tinuvin™ 479, Tinuvin™ 1577 ED, Tinuvin™ 1600 from BASF, 2-(2,4-dihydroxyphenyl)-4,6-bis-(2,4-dimethylphenyl)-s-triazine (CASRN1668-53-7) from Capot Chemical Ltd and 4-[4,6-bis(2-methyl-phenoxy)-1,3,5-triazin-2-yl]-1,3-benzenediol (CASRN13413-61-1); titanium dioxide such as Solasorb 100F from from Croda Chemicals; zink oxide such as Solasorb 200F from Croda Chemicals; benzoxazines such as Cyasorb UV-3638 F, CYASORB™ UV-1164 from CYTEC; and oxamides such as Sanduvor VSU from Clariant.

Preferred UV absorbers have in the wavelength region between 300 and 400 nm a maximum absorption above 330 nm, more preferably above 350 nm.

Particular preferred UV absorbers are hydroxyphenyl benzotriazoles and 2-hydroxyphenyl-s-triaznes having a maximum. absorption above 350 nm in the wavelength region 300-400 nm.

### Acid Scavenger

The laser markable composition may contain one or more acid scavengers.

Acid scavengers include organic or inorganic bases. Examples of the inorganic bases include hydroxides of alkali metals or alkaline earth metals; secondary or tertiary phosphates, borates, carbonates; quinolinates and metaborates of alkali metals or alkaline earth metals; a combination of zinc hydroxide or zinc oxide and a chelating agent (e.g., sodium picolinate); hydrotalcite such as Hycite 713 from Clariant; ammonium hydroxide; hydroxides of quaternary alkylammoniums; and hydroxides of other metals. Examples of the organic bases include aliphatic amines (e.g., trialkylamines, hydroxylamines and aliphatic polyamines); aromatic amines (e.g., N-alkyl-substituted aromatic amines, N-hydroxylalkyl-substituted aromatic amines and bis [p-(dialkylamino)phenyl]-methanes), heterocyclic amines, amidines, cyclic amidines, guanidines and cyclic guanidines.

Other preferred acid scavangers are HALS compounds. Example of suitable HALS include Tinuvin™ 292, Tinuvin™ 123, Tinuvin™ 1198, Tinuvin™ 1198 L, Tinuvin™ 144, Tinuvin™ 152, Tinuvin™ 292, Tinuvin™ 292 HP, Tinuvin™ 5100, Tinuvin™ 622 SF, Tinuvin™ 770 DF, Chimassorb™ 2020 FDL, Chimassorb™ 944 LD from BASF; Hostavin 3051, Hostavin 3050, Hostavin N 30, Hostavin N321, Hostavin N 845 PP, Hostavin PR 31 from Clariant.

Further examples of acid scavengers are salts of weak organic acids such as carboxylates (e.g. calcium stearate).

A preferred acid scavenger is an organic base, more preferably an amine. A particular preferred acid scavenger is an organic base having a pKb of less than 7.

### Lasermarking

Laser marking is carried out with a NIR laser. The NIR laser has preferably an emission wavelength between 750 and 2500, more preferably between 800 and 1500 nm in the laser marking step.

The NIR laser may be a continuous wave or a pulsed laser.

A particularly preferred NIR laser is an optical pumped semiconductor laser. Optically pumped semiconductor lasers have the advantage of unique wavelength flexibility, different from any other solid-state based laser. The output wavelength can be set anywhere between about 920 nm and about 1150 nm. This allows a perfect match between the laser emission wavelength and the absorption maximum of an optothermal converting agent present in the laser markable layer.

A preferred pulsed laser is a solid state Q-switched laser. Q-switching is a technique by which a laser can be made to produce a pulsed output beam. The technique allows the production of light pulses with extremely high peak power, much higher than would be produced by the same laser if it were operating in a continuous wave (constant output) mode, Q-switching leads to much lower pulse repetition rates, much higher pulse energies, and much longer pulse durations.

Laser marking may also be carried out using a so-called Spatial Light Modulator (SLM) as disclosed in WO2012/044400 (Vardex Laser Solutions).

### Laser Markable Article

The laser markable article according to the present invention is prepared by applying the laser markable composition according to the present invention on a support.

The laser markable composition may be provided onto a support by co-extrusion or any conventional coating technique, such as dip coating, knife coating, extrusion coating, spin coating, spray coating, slide hopper coating and curtain coating.

The laser markable composition may also be provided onto a support by any printing method such as intaglio printing, screen printing, flexographic printing, offset printing, inkjet printing, rotogravure printing, etc.

Using a printing method is preferred when only a part or several parts of a support has to be provided with the laser markable composition.

The laser markable article maybe selected from a packaging, a foil, a laminate, a security document, a label, a decorative object or an RFID tag.

### Support

The laser markable composition may be applied on any type of surface, for example a metallic support, a glass support, a polymeric support, or a paper support. The laser markable composition may also be applied on a textile surface.

The support may be provided with a primer to improve the adhesion between the support and the laser markable composition.

A primer containing a dye or a pigment, for example a white primer, may also be provided on the support, for example to improve the contrast of the laser marked image.

The support may be a paper support, such as plain paper or resin coated paper, e.g. polyethylene or polypropylene coated paper.

There is no real limitation on the type of paper and it includes newsprint paper, magazine paper, office paper, or wallpaper but also paper of higher grammage, usually referred to as paper boards, such as white lined chipboard, corrugated (fiber) board and packaging board.

Also, so-called synthetic papers, such as the Synaps™ synthetic papers from Agfa Gevaert, which are opaque polyethylene terephthalate sheets, may be used as support.

There is no restriction on the shape of the support. It can be a flat sheet, such a paper sheet or a polymeric film or it can be a three dimensional object like e.g. a plastic coffee cup.

The three dimensional object can also be a container like a bottle or a jerry-can for including e.g. oil, shampoo, insecticides, pesticides, solvents, paint thinner or other type of liquids.

Suitable polymeric supports include cellulose acetate propionate or cellulose acetate butyrate, polyesters such as polyethylene terephthalate and polyethylene naphthalate, polyamides, polycarbonates, polyimides, polyolefins, polyvinylchlorides, polyvinylacetals, polyethers, polysulfonamides, polylactide (PLA) and polyimide.

A preferred polymeric support is a biaxially stretched polyethylene terephthalate foil (PET-C foil) due to its resistance to scratches and chemical substances.

The manufacturing of PET-C foils and supports is well-known in the art of preparing suitable supports for silver halide photographic films. For example, GB 811066 (ICI) teaches a process to produce biaxially oriented polyethylene terephthalate foils and supports.

The polymeric support may be a single component extrudate or co-extrudate. Examples of suitable co-extrudates are PET/PETG and PET/PC.

The laser markable composition may also be applied on a so-called shrink foil. Such a foil shrinks tightly over whatever it is covering when heat is applied.

The most commonly used shrink foils are polyolefin foils, i.e. polyethylene or polypropylene foils. However, other shrink foils include PCV foils.

### Packaging

A preferred laser markable article is packaging.

Laser marking is typically used to add variable data, for example batch numbers, expiry dates, addressees, etc. on the packaging.

Preferably laser marking is carried out in-line in the packaging process.

The laser marked “image” on a packaging may comprises data, images, barcodes, QR codes, or a combination thereof.

An advantage of using laser marking in a packaging process is the ability to mark information through a wrapping foil, for example the flavour-protective foil used for cigarette packs. In such a way, variable data may be provided on the cigarette packs after the protective foil has already been provided.

Another preferred laser markable packaging is used for pharmaceutical packaging. For pharmaceutical packaging, track and trace requirements become more and more demanding to comply with the ever evolving legislation.

Another advantage of using laser marking instead of another printing technique, such as inkjet printing, is the absence of any chemicals in the marking process. Especially for pharmaceutical and food packaging, the absence of chemicals in the packaging line is a great advantage.

By selecting a proper leuco dye, or a mixture of leuco dyes, the package may be provides with data or images in any colour.

A preferred packaging is folded cardboard or corrugated cardboard laminated with paper. Such packaging is preferably used for cosmetics, pharmaceuticals, food or electronics.

Multiple colour, even full colour, images may be obtained when the packaging is provided with multiple laser markable compositions, each containing a different leuco dye and optothermal converting agent, as disclosed in EP-A2719540 (Agfa Gevaert) and EP-A 2719541 (Agfa Gevaert).

### Security Documents

The laser markable compositions may also be used to prepare security document, such as for example ID cards.

Typically, laser markable security documents are prepared by laminating a laser markable foil or laminate, optionally together with other foils or laminates, onto one or both sides of a core support.

Such laser markable security documents and their preparation have been disclosed in for example WO2015/091782 (Agfa Gevaert).

The laser markable laminate may be prepared by providing, a laser markable composition according to the present invention on a support. The support is described above and is preferably a transparent polymeric support.

The laser markable laminate may comprise more than one laser markable layers or may comprise additional layers such an ink receiving layer, a UV absorbing layer, intermediate layers or adhesion promoting layers.

The laser markable laminate is typically laminated on one or both sides of a core support using elevated temperatures and pressures.

Preferred core supports are disclosed in WO2014/057018 (Agfa Gevaert), paragraphs [0112] to [0015].

The lamination temperature depends on the type of core support used. For a polyester core, lamination temperatures are preferably between 120 and 140° C., while they are preferably above 150° C. -160° C. for a polycarbonate core.

### EXAMPLES

### Materials

All materials used in the following examples were readily available from standard sources such as ALDRICH CHEMICAL Co. (Belgium) and ACROS (Belgium) unless otherwise specified. The water used was deionized water.

PVB is polyvinyl butyral commercially available as S-LEC BL-10 from SEKISUI.

MEK is an abbreviation used for methylethylketone.

Tronox® CR-834 is a low-alumina-treated rutile TiO₂ pigment commercially available from TRCNOX.

EFKA 7701 is a high-molecular-weight polymeric dispersant commercially available from BASF.

MIX-1 is a mixture forming a polymerization inhibitor having a composition according to Table 2.

TABLE 2

| Component | wt % |
|---|---|
| DPGDA | 82.4 |
| p-methoxyphenol | 4.0 |
| 2,6-di-tert-butyl-4- | 10.0 |
| methylphenol | |
| Cupferron ™ AL | 3.6 |

DPGDA is dipropylenediacrylate, available as Sartomer SR508 from ARKEMA.

Cupferron™ AL is aluminum N-nitrosophenylhydroxylamine from WAKO CHEMICALS LTD.

Phenoxyethylacrylate is a monofunctional acrylic monomer commercially available from ARKEMA.

TBCH is 4-tert.butylcyclohexylacrylate, a monofunctional acrylic monomer commercially available under the trade name of Sartomer CD217 from SARTOMER.

ViCl is N-vinylcaprolactam, a reactive diluent commercially available from BASF.

TPO is 2,4,6-trimethylbenzoyldiphenylphosphine oxide, supplied by RAHN AG.

Genomer 1122 is monofunctional urethane acrylate commercially available from RAHN AG.

Sartomer CN963B80 is an aliphatic polyester based urethane diacrylate monomer commercially available from SARTOMER.

Esacure KTO 46 is a photoinitiator mixture of trimethylbenzoyldiphenylphosphine oxide, α-hydroxyketones, and benzophenone derivatives, commercially available from LAMBERTI.

Tegoglide 410 is a wetting agent commercially available from EVONIK.

Irgastab UV 10 is Bis (2,2,6,6-tetramethyl-1-piperidinyloxy-4-yl) sebacate (CASNR 2516-92-9) commercially available from CHEMOS GMBH.

WINCON-RED is a leuco dye commercially available from CONNECT CHEMICALS.

Cyclohexyl p-toluenesulfonate is a developing agent commercially available from TCI.

Takenate D120N is an aliphatic triisocyanate commercially available from Mitsui.

Mowiol 4 88 is a polyvinyl alcohol commercially available from Hoechst.

### Example 1

### Preparation of the NIR Absorbing Compounds

The NIR absorbing compounds IR-01 to IR-17 and IR-C1 to IR-C4 were synthesized using the synthetic methods disclosed in EP-A 2463109 (Agfa Gevaert), paragraphs [0150] to [0159].

As an example, the synthesis of IR-02 is described in more detail below.

### Preparation of INT-01

Step 1

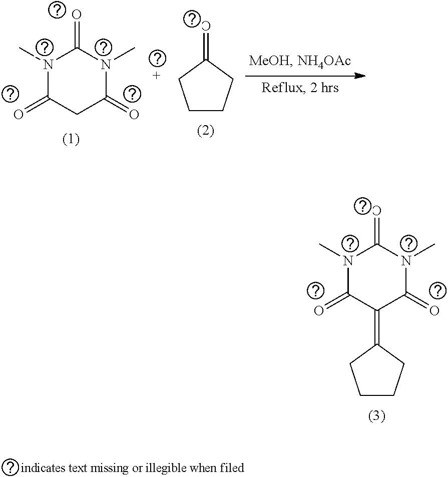 [SMILES: CN1C(=O)CC(=O)N(C)C1=O ; O=C1CCCC1 ; CN1C(=O)C(=C2CCCC2)C(=O)N(C)C1=O]

Compound (1) (0.8 mol, 1 equiv., 124.8g) and compound (0.16 mol, 2 equivs., 134.4 g) were dissolved in MeOH (250 mL). 1 g ammonium acetate (NH₄OAc) was then added and the reaction mixture was stirred at reflux for 2 hours. 50 mL methanol (MeOH) was then added and the reaction mixture was allowed to cool down.

The precipitate was collected by filtration and washed with MeOH/H₂O (4/1) and methyl-tert-butylether (MTBE). The product (3) was obtained with a yield of 77%.

Step 2

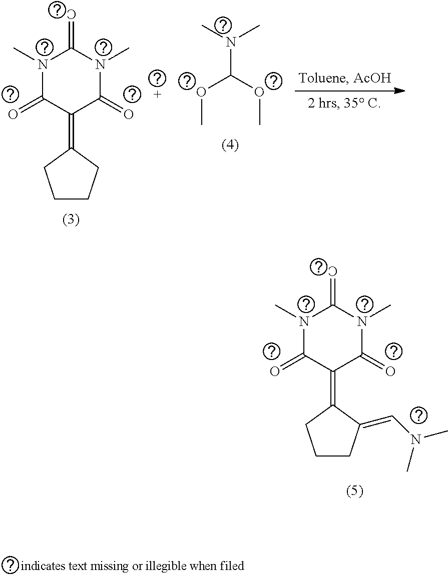

Compound (3) (0.566 mol, 1 equiv., 126 g) was dissolved in toluene (700 mL). The acetic acid was added (0.56 mol, 1 equiv., 34 g) and the reaction mixture was stirred for 5 minutes. Compound (4) (0.68 mol, 1.2 equivs., 81 g) was then added and the reaction mixture was stirred at 35° C. for 2 hours. After cooling, compound (5) was collected by filtration and washed with MTBE.

The product was obtained with a yield of 94%.

Step 3

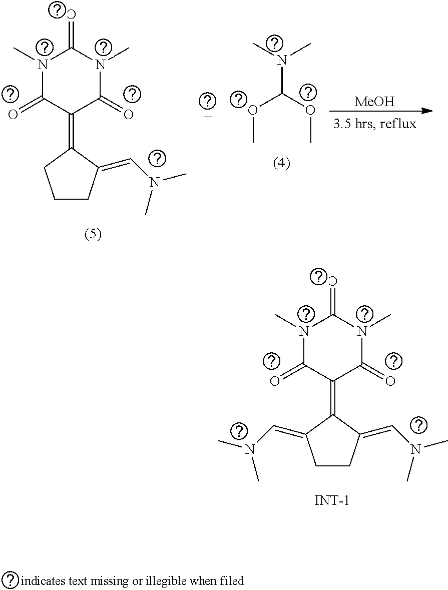

At reflux, compound (5) (0.52 mol, 1 equiv., 144 g) was dissolved in MeOH (400 mL). Compound (4) (2.56 mol, 4.9 equivs., 306 g) was added dropwise over 3.5 hours. The reaction mixture was stirred at reflux for another 30 min; then cooled down to 3° C. and stirred during 15 min.

The product was collected by filtration and first washed with MeOH/MTBE (1/3) and then with MTBE.

INT-1 was obtained with a yield of 68%.

### Preparation of INT-02

Step 4

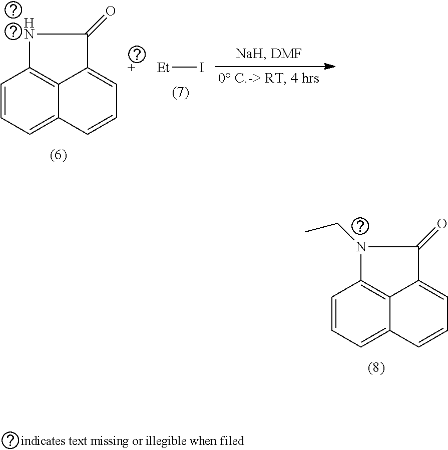

Compound (6) (6.65 g, 39 mmol, 1 equiv.) and NaH (2.81 g, 117 mmol, 3 equivs.) were dissolved in 100 mL dimethylformamide (DMF) and cooled to 0° C. Ethyl iodide (7.33 g, 47 mmol, 1.2 equivs.) was then added dropwise. The reaction mixture was stirred at 0° C. for 30 minutes. Then, the reaction mixture was stirred at room temperature for another 4 hours. After completion, ice water (200 mL) was added. The reaction mixture was extracted with ethyl acetate (2×150 mL). The organic layer was washed with brine (i.e. a saturated. NaCl solution) and dried over MgSO₄. The solid was filtered off and the filtrate was concentrated under reduced pressure.

The product was obtained with a yield of 92%.

Step 5

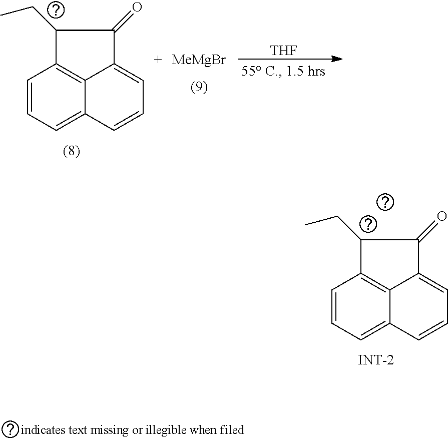

Under inert atmosphere, compound (8) (140 g, 0.7 mol, 1 equiv.) was dissolved in THF (220 mL) and compound (9) (270 mL of a solution of 22% in THF with d=1.03, 1.1 equivs.) was added dropwise over 30 minutes at a maximum temperature of 55° C. The reaction mixture was stirred for 1 hour at 55° C. After completion, the mixture was cooled down to 35° C. and poured into a mixture of H₂O/HCl (1700 mL/300 g, solution at 20° C.), with a constant air flow. NaI (120 g, 0.80 mol, 1.15 equivs.) was then added and the reaction mixture was stirred at 30° C. for 1 hour. The solid was filtered off and washed with H₂O and Acetone.

The product was obtained with a yield of 89%.

### Preparation of IR-2

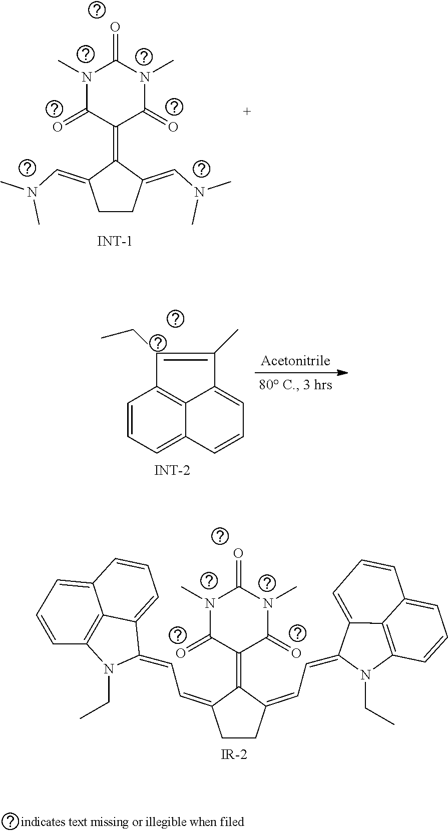

INT-1 (33 g, 0.1 mol, 1 equiv.) and INT-2 (79 g, 0.24 mol, 2.1 equivs.) were stirred in acetonitrile (700 mL) at 80° C. for 3 hours. After completion, the reaction mixture was allowed to cool down to room temperature. The solid was collected by filtration and washed with acetonitrile, MeOH and MTBE.

IR-2 was obtained with a yield of 85%.

The absorption maximum in the NIR region (λmax) of the compounds IR-01 to IR-17 and IR-C1 to IR-C4 (all measured in Methanol) are given in Table 3.

TABLE 3

| | NIR | λ max |
|---|---|---|
| Chemical structure | compounds | (nm) |
| 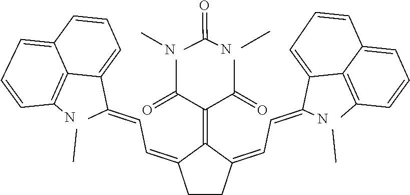 | IR-1 | 1019 |
| 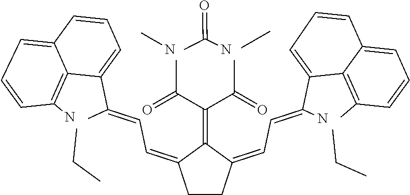 | IR-2 | 1019 |
| 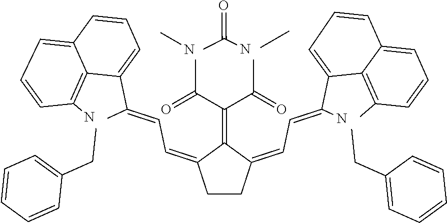 | IR-3 | 1016 |
| 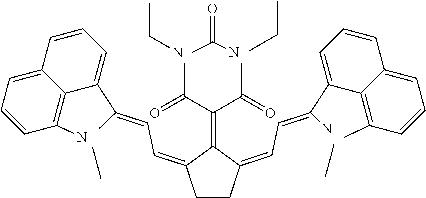 | IR-4 | NA |
| 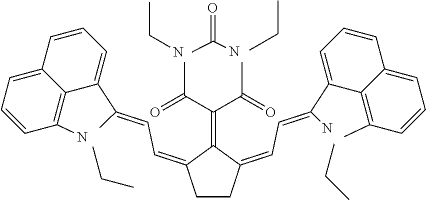 | IR-5 | 1020 |
| 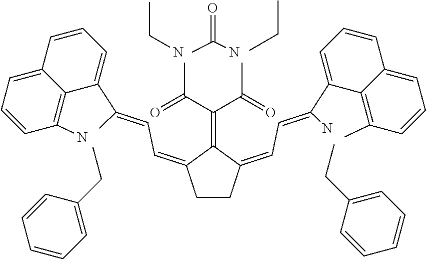 | IR-6 | 1022 |
| 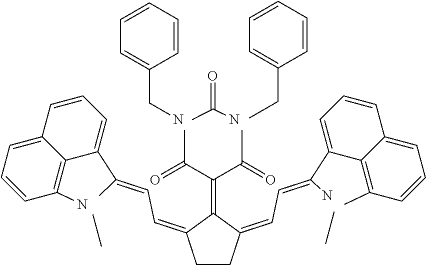 | IR-7 | 915 |
| 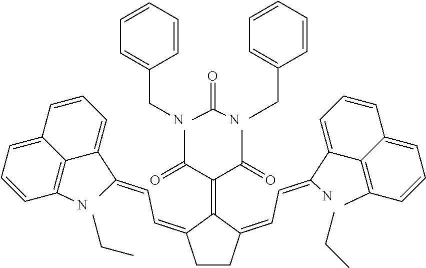 | IR-8 | 1019 |
| 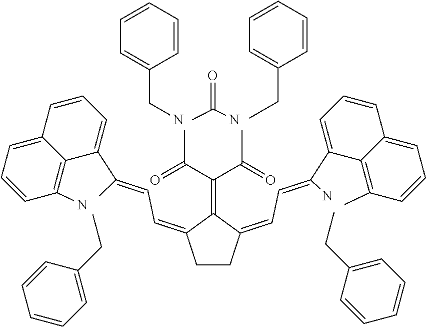 | IR-9 | 1019 |
| 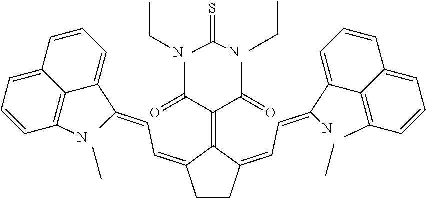 | IR-10 | 1021 |
| 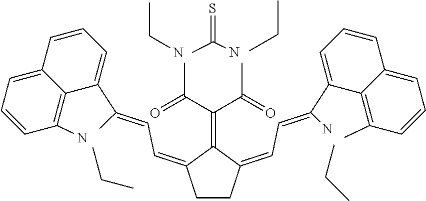 | IR-11 | 1028 |
| 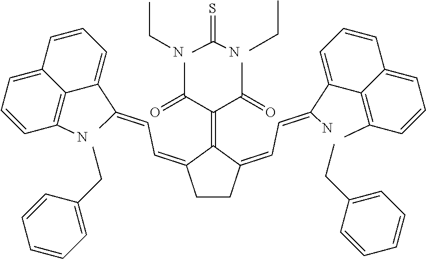 | IR-12 | 1025 |
| 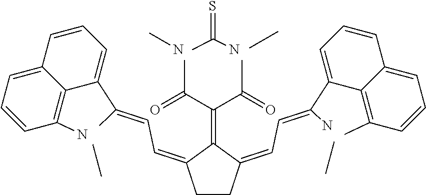 | IR-13 | 823 |
| 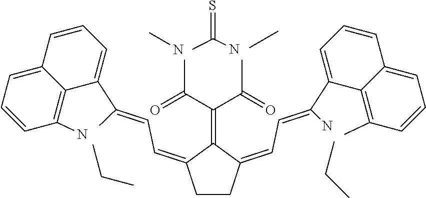 | IR-14 | 1025 |
| 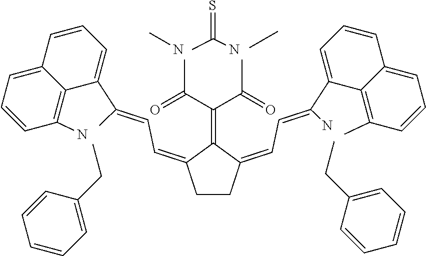 | IR-15 | 1026 |
| 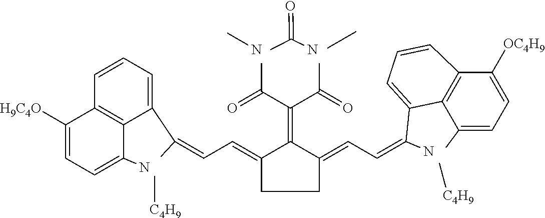 | IR-16 | 1083 |
| 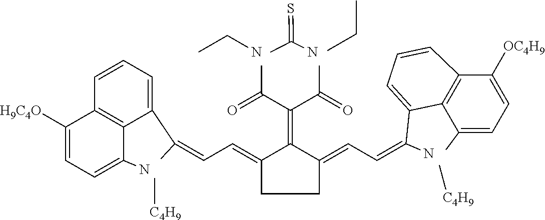 | IR-17 | 1090 |
| 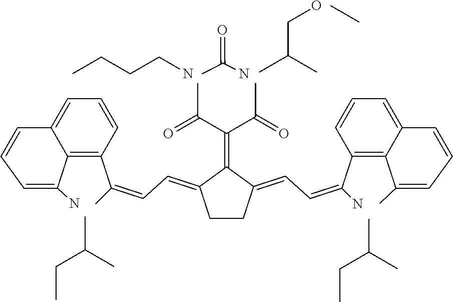 | IR-C1 | 1028 |
| 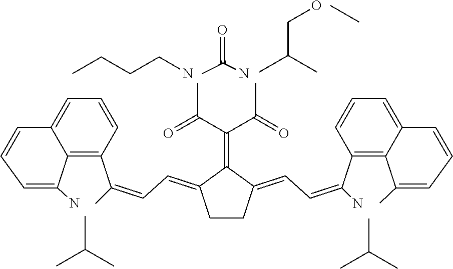 | IR-C2 | 887 |
| 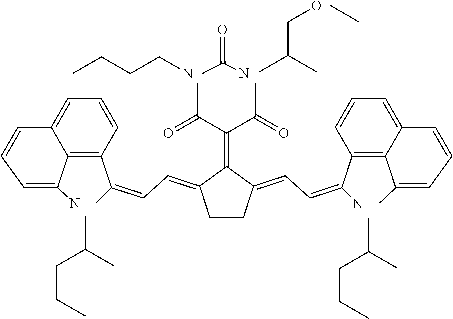 | IR-C3 | 1028 |
| 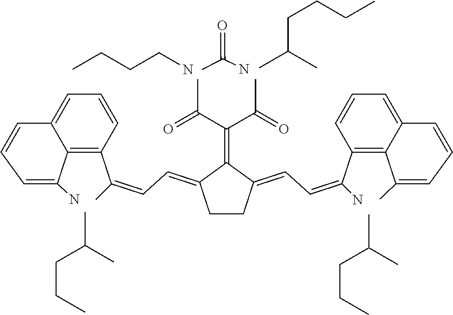 | IR-C4 | 1028 |

NA = Not Available

From Table 3 it is clear that all NIP compounds have an absorption maximum in methanol in the NIR region.

### Example 2

### Preparation of the IF Compound Dispersions IR-DISP-01 to IR-DISP-10

The Infrared dispersions IR-DISP-01 to IR-DISP-10 were prepared by mixing 0.4 g of the IR compounds according to Table 5 with 0.4 g of PBV into 39.2 of MEK and introduced into 100 ml plastic containers.

The containers were then filled with 160 g of 3 mm yttrium stabilized zirconia beads (high wear resistant zirconia grinding media from TOSOH Co.).

The containers were sealed and placed on rotating rolls for 7 days.

The stability of the IR compound dispersions were evaluated by monitoring the decrease of the absorption at the absorption maxima of the dispersions.

The absorption spectra were recorded using a SHIMADZU UV-2600 apparatus.

The stability of the dispersions was then quantified using the following criteria of Table 4.

TABLE 4

| Decrease absorption | |
|---|---|
| X (%) | Grade |
| 90 ≤ X | 5 |
| 75 ≤ X < 89 | 4 |
| 50 ≤ X < 74 | 3 |
| 25 ≤ X < 49 | 2 |
| 10 ≤ X < 24 | 1 |
| X < 10 | 0 |

The stability of the dispersions thus increases from Grade 5 to Grade 0.

The stability results are shown in Table 5. The stability results were measured after 4 or 6 weeks, as indicated in Table 5.

TABLE 5

| | IR | Stability | Time |
|---|---|---|---|
| IR-DISP | dye | (Grade) | (weeks) |
| IR-DISP-01 | IR-02 | 1 | 6 |
| IR-DISP-02 | IR-05 | 1 | 6 |
| IR-DISP-03 | IR-09 | 1 | 6 |
| IR-DISP-04 | IR-12 | 1 | 6 |
| IR-DISP-05 | IR-16 | 1 | 6 |
| IR-DISP-06 | IR-17 | 1 | 6 |
| IR-DISP-07 | IR-C1 | 5 | 4 |
| IR-DISP-08 | IR-C2 | 5 | 4 |
| IR-DISP-09 | IR-C3 | 5 | 4 |
| IR-DISP-10 | IR-C4 | 5 | 4 |

It is clear from the results of Table 5 that the inventive IR dispersions IR-DISP-01 to 06 have a substantial better stability compared to the comparative IR dispersions IR-DISP-07 to 10.

For the comparative IR dispersions, a degradation of the IR compound was observed already after 1 week. After 4 weeks, the degradation of the IR compounds was complete.

For the inventive IR dispersions, a minor degradation was observed only after 6 weeks.

### Example 3

### Preparation of the IR Absorbers Dispersions IR-DISP-11 to IR-DISP-16

The infrared dispersions IR-DISP-11 to IR-DISP-16 were prepared by mixing 0.4 g of the IR absorbers according to Table 6 with 2.67 q of a 15 wt % MOWIOL 4 88 solution (mater) into 36.93 g of water and introduced into 100 ml plastic containers.

The containers were then filled with 160 g of 3 mm yttrium stabilized zirconia beads (high wear resistant zirconia grinding media from TOSOH Co.).

The containers were sealed and placed on rotating roils for 7 days.

TABLE 6

| | IR-DISP- | IR-DISP- | IR-DISP- | IR-DISP- |
|---|---|---|---|---|
| Ingredients (g) | 11 | 12 | 13 | 14 |
| 15 wt % MOWIOL 4 88 | 2.67 | = | = | = |
| IR-02 | 0.4 | — | — | — |
| IR-05 | — | 0.4 | — | — |
| IR-09 | — | — | 0.4 | — |
| IR-12 | — | — | — | 0.4 |

| Ingredients (g) | IR-DISP-15 | IR-DISP-16 |
|---|---|---|
| 15 wt % MOWIOL 4 88 | 2.67 | = |
| IR-16 | 0.4 | — |
| IR-17 | — | 0.4 |

### Preparation of the Developing Agent Dispersion DEVELOP

The DEVELOP dispersion was prepared as follows:

In Pot A, 55 g of Arlo, 4.4 g Proxel Ultra 5 (commercially available from Avecia) and 366.674 g of a 15 wt % MOWIOL 4 88 solution (water) were added to 524.601 g water. The mixture was stirred for 5 minutes at 50° C. in order to dissolve all components.

In Pot B, 10.725 p 4,4′-Thiobis(6-tent-butyl-m-cresol) (commercially available from TCI Europe), 10.725 g Ralox 46 (commercially available from Raschig), 33 g Tinuvin 928 (commercially available from BASF), 8.25 g DISFLAMOLL IMP (commercially available from Lanxess), 4.125 g Ethyl Maleate (commercially available from TCI Europe) and 181.5 p Zinc 3,5-bis(alpha methylbenzyl) salicylate (CASRN53770-52-8, commercially available from Sanko Europe) were added to 495 g ethyl acetate. The mixture was stirred for 30 minutes at 50° C. in order to dissolve all components.

While Pot A was stirred with a HOMO-REX high speed homogenizing mixer, the solution in Pot B was added to Pot A. The mixture was further stirred during 5 minutes with the HOMO-REX mixer. Ethyl acetate was removed from the mixture under reduced pressure.

### Preparation of the Leuco Dye Dispersion LD-DISP-01

LD-DISP-1 was made as follows:

13.98 g Yamamoto Red 40 (from Mitsui), 9.45 g Orange DCF and 20.13 g of Takenate D-120N (from Mitsui) were added to 101.4 g of ethyl acetate. The mixture was heated at reflux and stirred until all components were dissolved.

In a separate flask, 0.3 g of OLFINE E1010 (from Shin-Etsu Chemical Company LTD), 88.04 g of a 12 wt % MOWIOL 4 88 solution was added to 75.1 g of water and 16.2 g of ethyl acetate. The ethyl acetate-based solution was added to the aqueous solution. The mixture was cooled in an ice bath and emulsified using a T25 digital Ultra-Turrax® with an 18N rotor commercially available from IKA at 22000 rpm during 5 minutes.

Ethyl acetate was removed under reduced pressure. During the process, also 10 mL of water was evaporated and therefore, the same amount of water was added to the mixture after evaporation. 2.1 g tetraethylenepentamine (CAS 112-57-2) was added to the reaction mixture. The mixture was then stirred for 16 hours at 60 ° C. and afterwards cooled to 25° C.

### Preparation of the Laser Markable Compositions LM-01 to LM-06

The laser markable compositions LM-01 to LM-06 were prepared by mixing the ingredients of Table 7.

TABLE 7

| Ingredients (g) | LM-01 | LM -02 | LM -03 | LM -04 | LM-05 | LM-06 |
|---|---|---|---|---|---|---|
| IR-DISP-11 | 1.12 | — | — | — | — | — |
| IR-DISP-12 | — | 1.12 | — | — | — | — |
| IR-DISP-13 | — | — | 1.12 | — | — | — |
| IR-DISP-14 | — | — | — | 1.12 | — | — |
| IR-DISP-15 | — | — | — | — | 1.12 | — |
| IR-DISP-16 | — | — | — | — | — | 1.12 |
| LD-DISP-01 | 1 | 1 | 1 | 1 | 1 | 1 |
| DEVELOP | 5.28 | 5.28 | 5.28 | 5.28 | 5.28 | 5.28 |
| 20 wt % | 5.51 | 5.51 | 5.51 | 5.51 | 5.51 | 5.51 |
| MOWIOL 4 88 | | | | | | |
| Water | 2.09 | 2.09 | 2.09 | 2.09 | 2.09 | 2.09 |

The laser markable laminates LML-01 to LML-06 were prepared by coating the laser markable compositions LM-01 to LM-06 on a subbed, white polyethyleneterephthalate sheet (thickness=135 μm) with an Elcometer Bird Film Applicator (from Elcometer Instruments) at a wet coating of 50 μm and subsequently dried.

The dried laser markable laminates were then laser marked using an optically pumped semiconductor laser emitting at 1064 nm (Genesis MX 1064-10000 MTM from Coherent). The results are shown in Table 8.

TABLE 8

| | | Colour | Colour |
|---|---|---|---|
| | | before | upon |
| | | laser | laser |
| Laminate | IR dye | marking | marking |
| LML-01 | IR-02 | white | Red |
| LML-02 | IR-05 | white | Red |
| LML-03 | IR-09 | white | Red |
| LML-04 | IR-12 | white | Red |
| LML-05 | IR-16 | white | Red |
| LML-06 | IR-17 | white | Red |

From the results of Table 8 it is clear that all laser markable laminates could be laser marked by exposing them to a NIR laser.

### Example 4

### Preparation of the UV Curable Ink INK-01

INK-01 was prepared by mixing together the ingredients shown in Table 9.

TABLE 9

| Ingredients | wt % |
|---|---|
| Tronox CR834 | 16.00 |
| EFKA 7701 | 1.28 |
| MIX1 | 1.00 |
| Phenoxyethylacrylate | 34.12 |
| TBCH | 10.00 |
| ViCl | 20.00 |
| TPO | 2.95 |
| Genomer 1122 | 6.00 |
| Sartomer CN963B80 | 4.00 |
| Escacure KT 046 | 4.00 |
| Tegoglide 410 | 0.30 |
| Irgastab UV 10 | 0.35 |

### Preparation of the UV Curable Laser Markable Compositions LM-07 to LM-10

The UV curable laser markable compositions LM-07 to LM-10 were prepared by mixing together the ingredients of Table 10.

TABLE 10

| Ingredients (wt %) | LM-07 | LM-08 | LM-09 | LM-10 |
|---|---|---|---|---|
| INK-01 | 90.76 | = | = | = |
| Wincon-Red | 3.00 | = | = | = |
| Cyclohexyl | 6.00 | = | = | = |
| p-toluenesulfonate | | | | |
| IR-12 | 0.24 | — | — | — |
| IR-C1 | — | 0.236 | — | — |
| IR-C3 | — | — | 0.24 | — |
| IR-C4 | — | — | — | 0.25 |

### Preparation of the UV Curable Laser Markable Laminates LML-07 to LML-10

The UV curable laser markable laminates LML-07 to LML-10 were prepared by coating the laser markable compositions LM-07 to LM-10 on an unsubbed polyethylene terephthalate sheet (thickness=175 μm) with a Elcometer Bird Film Applicator (available from Elcometer Instruments) at a speed of 20 m/min and a wet coating thickness of 40 μm.

The coating was then UV cured using 3 passes through an UVIO curing station (20 m/min; D-bulb at 80% power; 880.5 mJ/cm² in one pass).

INK-01 was also coated and cured on the polyethylene terephthalate sheet to obtain LML-11.

### Laser Marking of the UV Cured Laser Markable Laminates LML-07 to LML-10 and LML-11

The UV cured laser markable laminates LML-07 to LML-10 and LML-11 were laser marked using the Coherent 1064 nm laser described above.

The laser marking results are shown in Table 11.

The minimum Optical Density (ODₘᵢₙ) is the Optical Density in non-laser marked areas of the laminate, while the maximum Optical Density (ODₘₐₓ) is the Optical Density in the laser marked areas of the laminate.

The Optical Densities were measured using a Macbeth TD904 (Transmission, using a Visual/Ortho Filter type Vlambda).

TABLE 11

| | | | Colour | | |
|---|---|---|---|---|---|
| | | | upon | | |
| | | Background | laser | | |
| Laminate | IR dye | Colour | marking | ODₘᵢₙ | ODₘₐₓ |
| LML-07 | IR-12 | white | Red | 0.96 | 2.50 |
| LML-08 | IR-C1 | grey | Red | 0.94 | 1.21 |
| LML-09 | IR-C3 | grey | Red | 0.93 | 1.00 |
| LML-10 | IR-C4 | grey | Red | 0.89 | 1.11 |
| LML-11 | — | white | — | 0.75 | — |

It is clear from the results of Table 11 that the laminate prepared with a laser markable composition according to the present invention (LML-07) has a much higher laser marked density compared to the other laminates.

The absorption spectra of the UV cured laminates indicate that the IR absorbers IR-C1 to IR-C3 decompose upon UV curing (the absorption at 1064 nm decreases upon UV curing) resulting in lower laser marking densities. The absorption at. 1064 nm of IR-12 however does not substantially changes upon UV curing, resulting in high laser marked densities.

The decomposition of IR-C1 to IR-C3 also results in a grey background colour of the laminates.

1-15 (canceled)

16. A laser markable composition comprising:
a Near InfraRed (NIR) absorbing compound; and
a color forming agent; wherein
the NIR absorbing compound has a chemical structure according to Formula I: 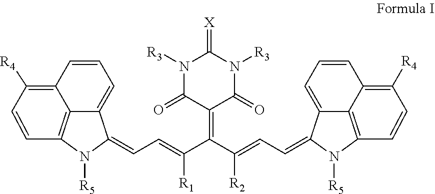
wherein
X is O or S;
R₁ and R₂ represent atoms necessary to form a substituted or unsubstituted 5 or 6 membered ring;
R₃ and R₅ are independently selected from the group consisting of an unsubstituted alkyl group, an unsubstituted alkenyl group, an unsubstituted alkynyl group, an unsubstituted aralkyl group, an unsubstituted alkaryl group, and a substituted or unsubstituted (hetero)aryl group;
R₄ is selected from the group consisting of a hydrogen, an unsubstituted alkyl group, an unsubstituted alkenyl group, an unsubstituted alkynyl group, an unsubstituted aralkyl group, an unsubstituted alkaryl group, a substituted or an unsubstituted (hetero)aryl group, a halogen, an unsubstituted alkoxy group, a substituted or an unsubstituted aryloxy group, a substituted or an unsubstituted heteroaryloxy group, an ester, an amine, an amide, a nitro, a thioalkyl group, a substituted or an unsubstituted thioaryl group, a substituted or an unsubstituted thioheteroaryl group, a carbamate, a carbamide, a sulfonamide, a sulfoxide, and a sulfone; and
all hydrocarbon groups in Formula I are straight chain hydrocarbon groups.

17. The laser markable composition according to claim 16, wherein R₃ and R₅ are independently selected from the group consisting of an unsubstituted alkyl group, an unsubstituted alkaryl group, and an unsubstituted (hetero)aryl group.

18. The laser markable composition according to claim 16, wherein R₃ and R₅ are independently selected from the group consisting of a lower alkyl group containing no more than six carbon atoms and an unsubstituted alkaryl group.

19. The laser markable composition according to claim 16, wherein R₃ and R₅ are independently selected from the group consisting of a methyl group, an ethyl group, a n-propyl group, a n-butyl group, a benzyl group, and an aryl group.

20. The laser markable composition according to claim 16, wherein R₄ is selected from the group consisting of a hydrogen, a halogen, a straight chain unsubstituted alkyl group, and a straight chain unsubstituted alkoxy group.

21. The laser markable composition according to claim 16, wherein R₄ is selected from the group consisting of a hydrogen, a chlorine, a bromine, a methyl, an ethyl, a methoxy group, an ethoxy group, a n-propoxy group, and a n-butoxy group.

22. The laser markable composition according to claim 16, wherein the NIR absorbing compound has a chemical structure according to Formula II: 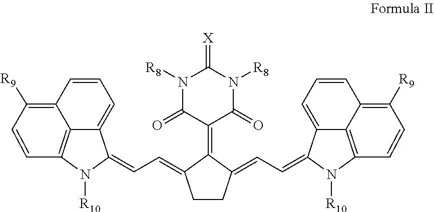
wherein
X is O or S;
R₈ and R₁₀ are independently selected from the group consisting of an unsubstituted alkyl group, an unsubstituted alkenyl group, an unsubstituted alkynyl group, an unsubstituted aralkyl group, an unsubstituted alkaryl group, and a substituted or unsubstituted (hetero)aryl group; and
R₉ is selected from the group consisting of a hydrogen, an unsubstituted alkyl group, an unsubstituted alkenyl group, an unsubstituted alkynyl group, an unsubstituted aralkyl group, an unsubstituted alkaryl group, a substituted or an unsubstituted (hetero)aryl group, a halogen, an unsubstituted alkoxy group, a substituted or an unsubstituted aryloxy group, a substituted or an unsubstituted heteroaryloxy group, an ester, an amine, an amide, a nitro, a thioalkyl group, a substituted or an unsubstituted thioaryl group, a substituted or an unsubstituted thioheteroaryl group, a carbamate, a carbamide, a sulfonamide, a sulfoxide, and a sulfone.

23. The laser markable composition according to claim 22, wherein R₉ is selected from the group consisting of a hydrogen, a chlorine, a bromine, a methyl, an ethyl, a methoxy group, an ethoxy group, a n-propoxy group, and a n-butoxy group.

24. The laser markable composition according to claim 16, wherein the color forming agent includes a leuco dye.

25. The laser markable composition according to claim 24, further comprising a developing agent or a developing agent precursor.

26. A laser markable article comprising:
a support; and
the laser markable composition as defined in claim 16 provided on the support.

27. The laser markable article according to claim 26, wherein the laser markable composition is printed on the support by intaglio printing, screen printing, flexographic printing, offset printing, inkjet printing, or rotogravure printing.

28. The laser markable article according to claim 26, wherein the laser markable article is selected from the group consisting of a packaging, a foil, a laminate, a security document, a label, a decorative object, and an RFID tag.

29. A method of preparing a laser marked article comprising:
exposing the laser markable article as defined in claim 26 with a NIR laser to form a laser marked image.

30. The method according to claim 29, wherein the laser marked image is selected from the group consisting of a barcode, a QR code, alphanumerical data, pictures, and logos.
